(19) United States
(12) Patent Application Publication
(10) Pub. No.: US 2006/0201559 A1
(43) Pub. Date: Sep. 14, 2006

(54) Valve arrangement for a hydraulic or pneumatic control device

(76) Inventors: Georg Ege, Kressbronn (DE); Peter Schnell, Nonnenhorn (DE)

Correspondence Address: DAVIS & BUJOLD, P.L.L.C., 112 PLEASANT STREET, CONCORD, NH, 03301, US

(21) Appl. No.: 11/369,484

(22) Filed: Mar. 7, 2006

(30) Foreign Application Priority Data
Mar. 11, 2005 (DE) 10 2005 011 275.7

(51) Int. Cl. F16K 11/052

(52) U.S. Cl. 137/625.44

(57) ABSTRACT

A valve arrangement for a hydraulic or pneumatic control device is proposed, which comprises a housing (4) with two ports (7, 8) provided on one side and a further port (9) on the other side, in particular the opposite side, in which a switching valve (6) and a throttle check-valve (1) are arranged in the housing (4) in a layered configuration, such that the control pressure medium can pass from the working valve (A) or (B), via the switching valve (6) and through the throttle check-valve (1) to a consumer (P) or vice-versa.

The present invention concerns a valve arrangement for a hydraulic or pneumatic control device, according to the preamble of claim 1.

From DE 103 13 484 A1 by the present Applicant, a control valve with a short switching time is known, which has a valve housing with two inlet ports and one outlet port in the inside space that can be filled with a control pressure medium, switching means that can move between two switching positions are arranged such that. in both switching positions. the switching means open one of the two inlet ports of the valve housing and close the other inlet opening, respectively. The switching means comprise two separate seals which, to open and close the inlet ports, are arranged to move along respective curved circular arc sections approximately coaxial with the inlet ports. By virtue of this control valve, very short switching times can be attained.

The purpose of the present invention is to indicate a valve arrangement for a hydraulic or pneumatic control device in which a consumer is actuated alternately via two different working valves with different volume flows for opening and closing, the arrangement having a compact structure. In addition, the valve arrangement, according to the invention, should be characterized by low pressure and flow losses.

These objectives are achieved by the characteristics of claim 1. Further features and advantages of the invention emerge from the subordinate claims.

Accordingly, a valve arrangement for a hydraulic or pneumatic control device is proposed, which comprises a housing with two ports provided on one side and a further port on another side, in particular the opposite side, in which a switching valve and a throttle check-valve are arranged in a layered configuration.

The valves are connected to one another in such a manner that the control pressure medium can pass from working valve A or B, via the switching valve, and through the throttle check-valve to a consumer and vice-versa.

By way of the switching valve with two switching positions, in each of the positions one of the two ports on one side of the valve housing is opened and the other port is closed, respectively. Moreover, the throttle check-valve is arranged between the switching valve and the consumer and is connected to the further opening that leads to the consumer.

The throttle check-valve is preferably made as a ball valve and integrated into the duct system of the cast valve plate. According to the invention, the contour of the valve space can be formed as a casting. Furthermore, the valve seat of the throttle check-valve, formed as a ball valve and the throttle bore, can be integrated in an intermediate plate.

The transition from the intermediate plate to the switching valve then leads directly into the valve space from the valve seat in the valve housing, which is preferably formed by casting. According to the invention, the valve seats of the switching valve are integrated in another intermediate plate provided on the side of the valve arrangement facing away from the consumer.

As the switching valve, as described in DE 103 13 484 A1 by the present Applicant, a valve can preferably be used in which switching means are arranged so as to move between two switching positions in such a manner that in both of the switching positions, the switching means open one of the inlet ports of the valve housing and close the other inlet port, respectively. For this, the switching means comprise two separate seal devices arranged to move along respective curved circular arc sections approximately coaxial with the inlet ports so as to open and close the latter.

According to the invention, the design provides a valve arrangement of simple structure that can be produced inexpensively, which can be used in particular to control shift elements of a motor vehicle transmission such as a clutch or brake. It is also possible to use simple insert components, for example, plastic elements, for individual valve parts.

Below, the invention is described in greater detail as an example, referring to the attached figures which show:

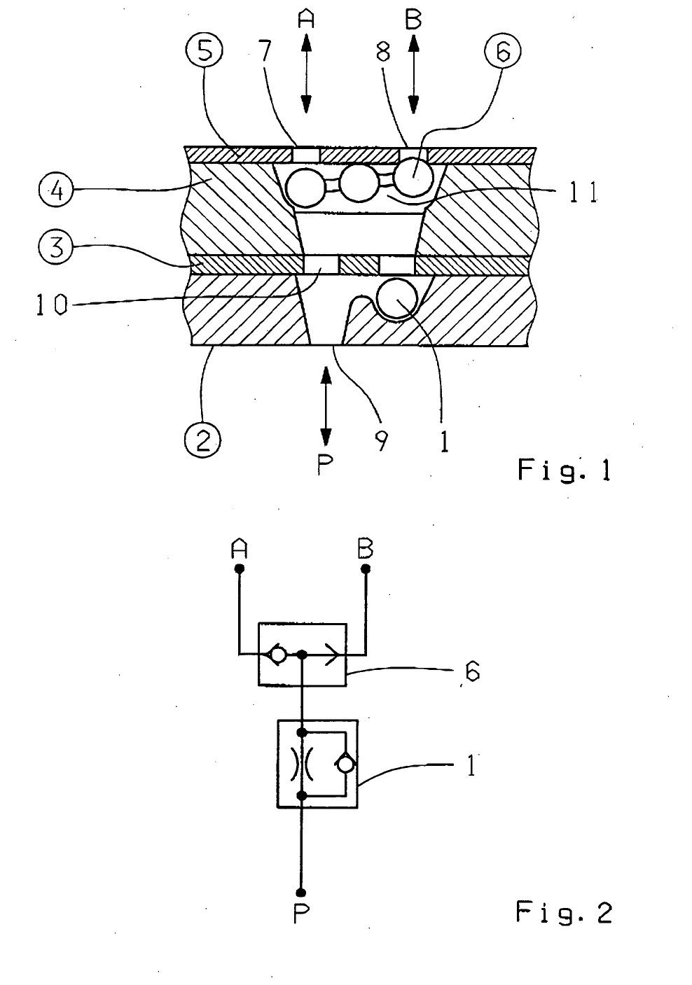

FIG. 1 is a schematic sectional view of a valve arrangement according to the invention; and

FIG. 2 is a schematic circuit diagram to explain the operation of the valve arrangement according to the invention.

FIG. 1 shows the valve arrangement according to the invention. It comprises a housing 4 with two ports 7, 8 on one side and another port 9 on the opposite side in which a switching valve 6 and a throttle check-valve 1 are arranged in a layered configuration. The valves are connected to one another in such a manner that the control pressure medium can pass from working valve A or B, via the switching valve and through the throttle check-valve to the consumer P and vice-versa.

The switching valve 6 has two switching positions in each of which, respectively, one of the two ports 7 or 8 provided in one side of the valve housing 4 is open and the other is closed. Through the respective ports 7 or 8, the control pressure medium can pass via one of two different working valves A or B with different volume flows. The throttle check-valve 1 is arranged between the switching valve 6 and a consumer P, and is connected to the port 9 leading to the latter.

As can be seen from FIG. 1, the throttle check-valve 1 is made as a ball valve integrated in the duct system of a cast valve plate 2, the contour of the valve space being formed by casting. Furthermore, the valve seat of the throttle check-valve 1 formed as a ball valve and a throttle bore 10 are integrated in an intermediate plate 3 so that the transition from the intermediate plate 3 to the switching valve 6 leads directly into the valve space from the valve seat in the valve housing, which is preferably made as a casting. As can also be seen from FIG. 1, the valve seats of the switching valve 6 are integrated in another intermediate plate 5 provided on the side of the valve arrangement facing away from the consumer P.

Preferably, the switching valve 6 comprises a switching means 11 arranged to move between two switching positions, such that in both switching positions the switching means 11 open one of the respective ports 7, 8 and close the other port.

FIG. 2 is a schematic circuit diagram to explain the operation of the valve arrangement. Depending on the valve position, the control pressure medium can flow through the switching valve 6 and the throttle check-valve 1 in the directions A-P, P-A, B-P or P-B.

By virtue of the invention, a compact arrangement in layered configuration is made available without additional machining of the castings and with very short paths and low pressure and flow losses.

Of course, any design configurations, in particular any spatial configurations of the components of the valve arrangement according to the invention, whether in their own right or in relation to one another, provided that they are technically appropriate, fall within the protective scope of the present claims without affecting the function of the valve arrangement, even if such configurations are not represented explicitly in the Figures or in the description.

Reference Numerals

1 throttle check-valve

2 valve plate

3 intermediate plate

4 valve housing

5 intermediate plate

6 switching valve

7 port

8 port

9 port

10 throttle bore

A working valve

B working valve

P consumer

1-5. (canceled)

6. A valve arrangement for one of a hydraulic and a pneumatic control device, the valve comprising:
a housing with two ports provided on one side and a further port on another side, in particular on an opposite side,
a switching valve (6) and a throttle check-valve (1) are arranged in the housing (4) such that a control pressure medium can flow from a working valve (A or B), via the switching valve (6) and through the throttle check-valve (1), to a consumer (P) and vice-versa.

7. The valve arrangement for one of the hydraulic and the pneumatic control device according to claim 6, wherein the switching valve (6) has two switching positions in which, respectively, a first of the two ports (7 or 8) is open and a second of the two ports (7 or 8) is closed such that the control pressure medium can flow with different volume through the two ports (7 or 8) via two different working valves (A or B), and such that the throttle check-valve (1) is arranged between the switching valve (6) and the consumer (P) and is connected to the further port (9) which leads to the consumer (P).

8. The valve arrangement for one of the hydraulic or the pneumatic control device according to claim 6, wherein the throttle check-valve (1) is a ball valve which is integrated in a duct system of a cast valve plate (2), a contour of a valve space is formed by casting, and a ball seat of the throttle check-valve (1) is a ball valve and a throttle bore (10) is integrated in an intermediate plate (3) such that a transition from the intermediate plate (3) to the switching valve (6) leads directly into the cast valve space from the valve seat in a valve housing (4).

9. The valve arrangement for one of the hydraulic or the pneumatic control device according to claim 6, wherein valve seats of the switching valve (6) are integrated in an intermediate plate (5) provided on a side of the valve arrangement facing away from the consumer (P).

10. The valve arrangement for one of the hydraulic or the pneumatic control device according to claim 6, wherein the switching valve (6) comprises switching means (11) arranged to move between first and second switching positions, such that in both the first and second switching positions, the switching means (11) respectively opens a first of the two ports (7, 8) and closes a second of the two ports (7, 8), the switching means (11) comprising two separate seal devices which are arranged to move along respective curved circular arc sections approximately coaxial with the inlet ports in order to open and close the two ports (7, 8).
